(19) United States
(12) Patent Application Publication
(10) Pub. No.: US 2002/0106444 A1
(43) Pub. Date: Aug. 8, 2002

(54) Process and device for applying a release agent to the rolls of a machine for the continuous casting of metal strips

(76) Inventors: Pierre-Yves Menet, Saint Jean De Moirans (FR); Patrick Golestin, Selestat (FR); Jean-Luc Stoecklin, Fortschwir (FR); Frederic Basson, Moirans (FR); Klaus Maiwald, Moirans (FR)

Correspondence Address: Ira J. Schultz, DENNISON, SCHEINER & SCHULTZ, Suite 612, 1745 Jefferson Davis Highway, Arlington, VA, 22202, US

(21) Appl. No.: 10/056,053

(22) Filed: Jan. 28, 2002

Related U.S. Application Data
(60) Provisional application No. 60/267,144, filed on Feb. 8, 2001.

(30) Foreign Application Priority Data
Feb. 8, 2001 (FR) 01 01724

(51) Int. Cl. B05D 1/00

(52) U.S. Cl. 427/8; 118/209; 118/227

(57) ABSTRACT

The invention relates to a process for the coating of the rolls of a twin-roll continuous casting machine wherein a release product containing a release agent, such as graphite, is applied and the composition of the release product is adjusted as it is applied to the rolls. The invention also relates to a device for coating the rolls of a twin-roll continuous casting machine which includes means for applying a release product and means for adjusting the composition of the release product while it is applied to the rolls. The invention makes it possible to improve control of the quality and distribution of the release product over the surface of the rolls.

### FIELD OF THE INVENTION

The invention relates to the continuous casting between rolls of metal strips, particularly aluminium and aluminium alloy strips. It relates most particularly to a process and a device for coating said rolls with a release product during casting.

### PRIOR ART

Twin-roll continuous casting technology is well known in the production of metal strips from a liquid metal source. Typically, liquid metal is injected into the gap separating two metal rolls in rotation, solidifies on contact with the latter and emerges in a solid state in the form of a strip.

Generally, unless particular precautions are taken, the solidified metal partially adheres to the surface of the rolls, which leads to a deterioration in the quality of the strip, and even to the stoppage of the casting. In order to avoid this so-called “sticking” phenomenon, which becomes more and more marked the higher the productivity of the installation, there is a known technique of coating the working surface of the rolls by spraying a liquid release product (also called a “lubricant”) by means of nozzles or guns. The release product is often a mixture of water and graphite particles. The release product is normally applied continuously, i.e. the working surface of a roll is coated in an approximately continuous way with the release product.

Known coating devices include one or more spray means per roll which may be fixed or mobile.

French patent applications FR 2 498 099 (corresponding to U.S. Pat. No. 4,501,315) and FR 2 621 839 (corresponding to U.S. Pat. No. 4,892,133) describe adjustable flow coating devices including release product dispensing ramps equipped with spray means placed linearly along the rolls.

International patent application WO 95/09707 describes a coating device equipped with nozzles for spraying the release product aligned along the rolls and collected into zones, each zone being supplied separately with the release product depending on the width of the metal strip. A part of the nozzles may be driven in an oscillatory motion parallel to the axis of the rolls.

### STATEMENT OF THE PROBLEM

In the context of its continuous efforts to develop machines and processes for the twin-roll continuous casting of metal strips, the applicant has acknowledged that known coating processes and devices do not allow the sticking phenomena to be avoided in all conditions of industrial production of metal strips.

The applicant has therefore sought solutions to improve the coating of the rolls of machines for the continuous casting of metal strips.

### DESCRIPTION OF THE INVENTION

The object of the invention is a process for coating the rolls of a twin-roll continuous casting machine in which at least one release product is applied containing a release agent, such as a graphite suspension, which is characterised in that it includes an adjustment of the composition of said release product while it is applied to said rolls.

Another object of the invention is a process for twin-roll continuous casting of metal strips including a process of coating according to the invention.

Another object of the invention is a device for coating rolls which is suitable for use in a twin-roll continuous casting machine, which includes means for applying at least one release product and which is characterised in that it includes means to adjust the composition of said release product while it is applied to said rolls.

Another object of the invention is a twin-roll continuous casting machine of metal strips equipped with a coating device according to the invention.

Another object of the invention is a process for regulating a twin-roll continuous casting machine of metal strips including the application of at least one release products to said rolls, said release product containing a release agent, such as graphite, which is characterised in that it includes an adjustment of the composition of said release products while it is applied to said rolls. Said adjustment is to advantage carried out as a function of the operating conditions of said machine.

Said continuous casting may be horizontal, inclined relative to the horizontal or vertical (upward or downward).

To obtain optimum coating effectiveness, the applicant has sought to control the quantity and distribution of the release product which is deposited on the working surface of the rolls. In fact it has observed in the course of its experiments that, contrary to generally received wisdom, changes in the flow of the spray means modified not only the quantity of release product deposited on the rolls but also the distribution of said product over their working surface, with as a consequence, particularly, uncontrolled variations in the effectiveness of the coating, particularly with regard to the stability of the casting machine and to the quality of the strip produced. It particularly noted that variations in flow of the release product sprayed over the working surface of a roll by a spray means may produce variations in the distribution of the release agent within the spray cone or “jets” and over the impact surface, whereas, generally, variations in the composition of the release product do not modify said distribution in a significant way.

To solve the problem posed to the invention, the applicant has had the idea of adjusting the composition of the release product while it is applied, which allows the quantity of release agent brought to the roll surface to be adjusted while restricting the heterogeneity of distribution of said agent. The release product may be a suspension, a solution or a mixture thereof.

The invention will be better understood by means of the figures and the detailed description which follow.

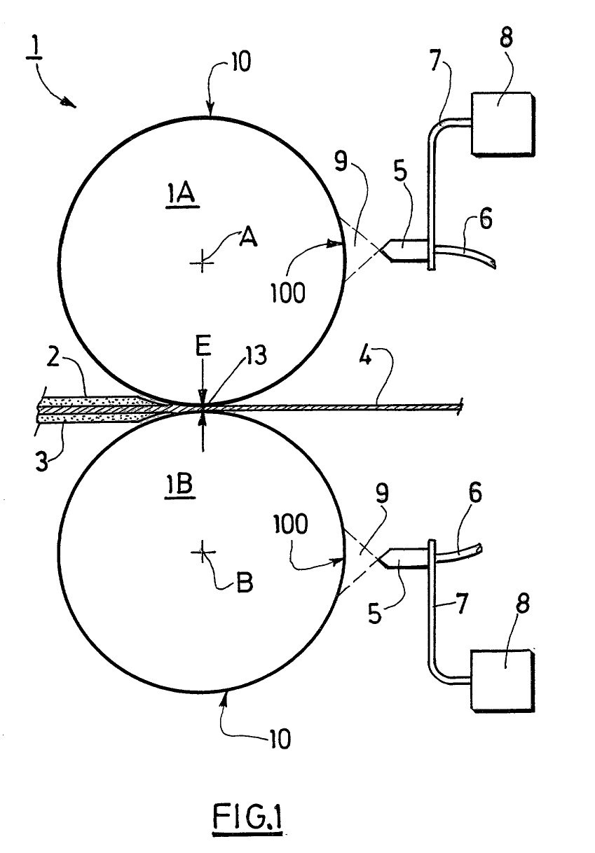

FIG. 1 diagrammatically shows, seen from the side, a twin-roll continuous casting machine equipped with coating means typical of the prior art.

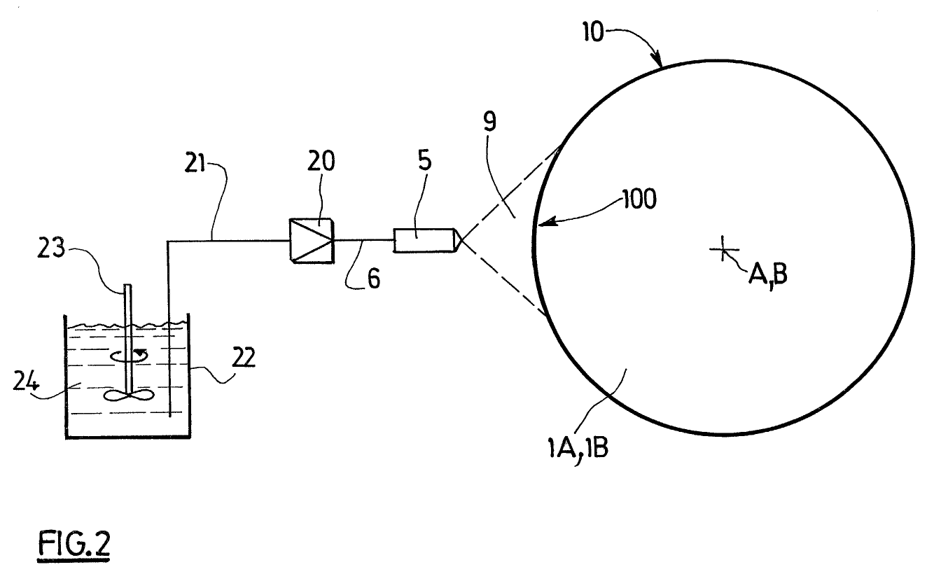

FIG. 2 is a diagrammatic view of a device for coating a twin-roll continuous casting machine of the prior art.

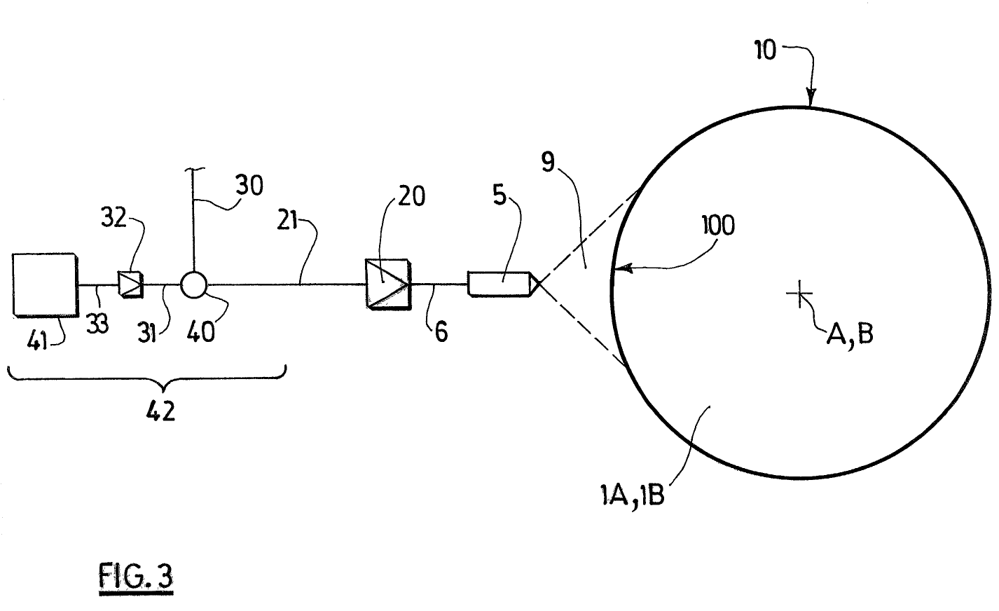

FIG. 3 is a diagrammatic view of a preferred embodiment of a device for coating a twin-roll continuous casting machine according to the invention.

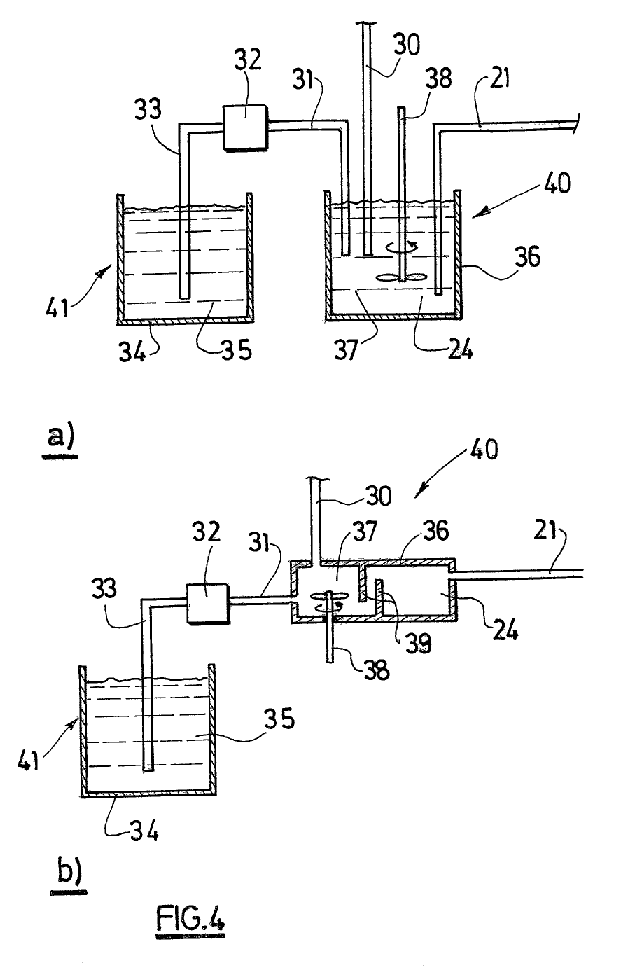

FIG. 4 diagrammatically shows variants of a part of the device for coating a twin-roll continuous casting machine according to the invention.

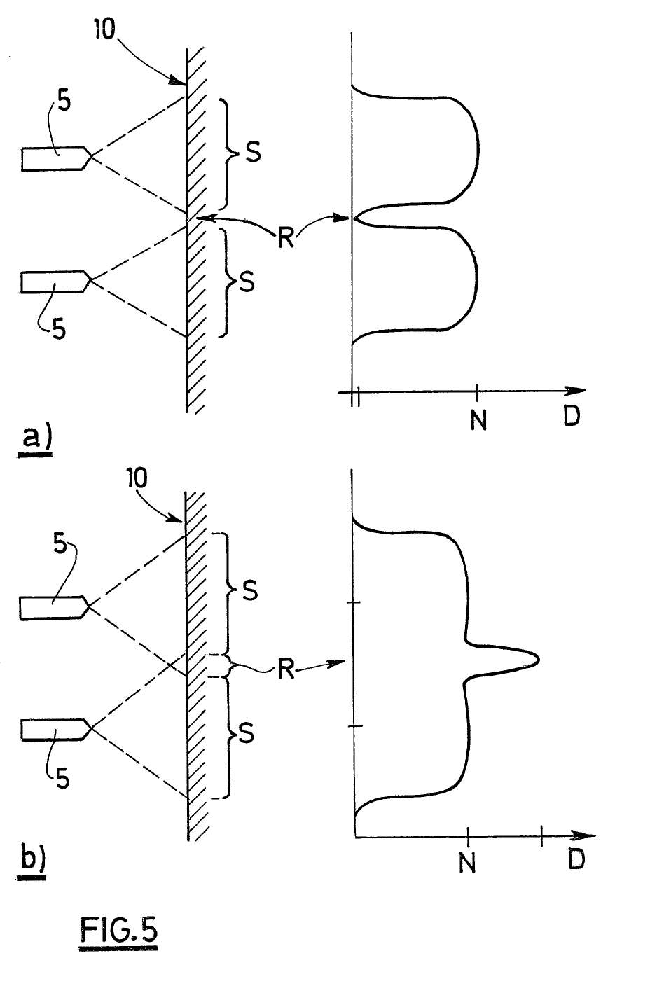

FIG. 5 shows the influence of a variation in the jet of release product of juxtaposed spray means on the distribution of the release product over the surface of a roll.

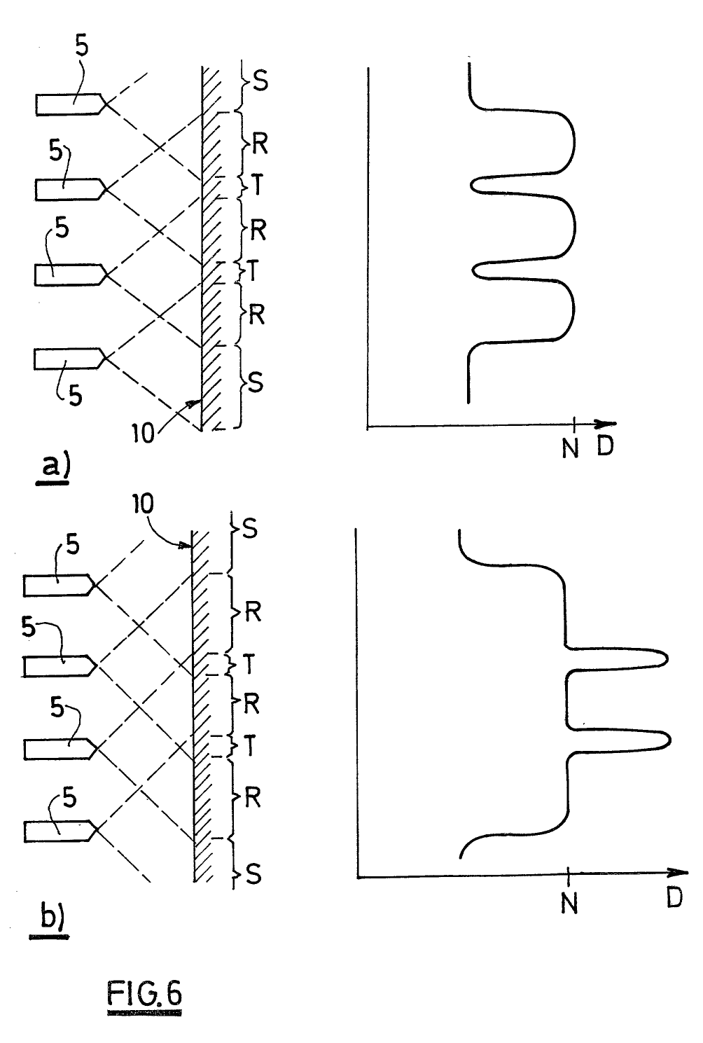

FIG. 6 shows the influence of a variation in the jet of release product of juxtaposed spray means on the distribution of the release product over the surface of a roll in the case of a strong overlap between jets.

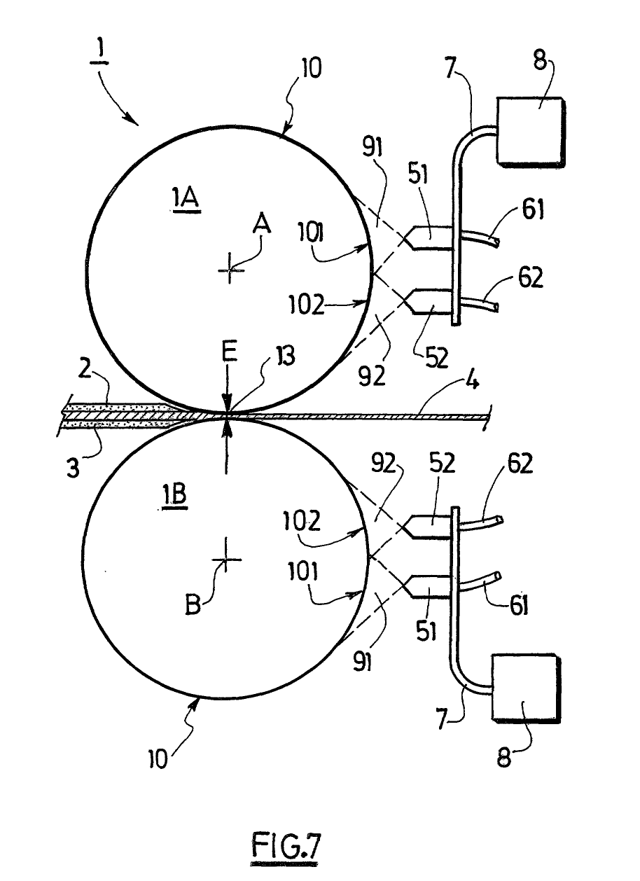

FIG. 7 diagrammatically shows, seen from the side, a twin-roll continuous casting machine equipped with coating means according to a possible embodiment of the invention.

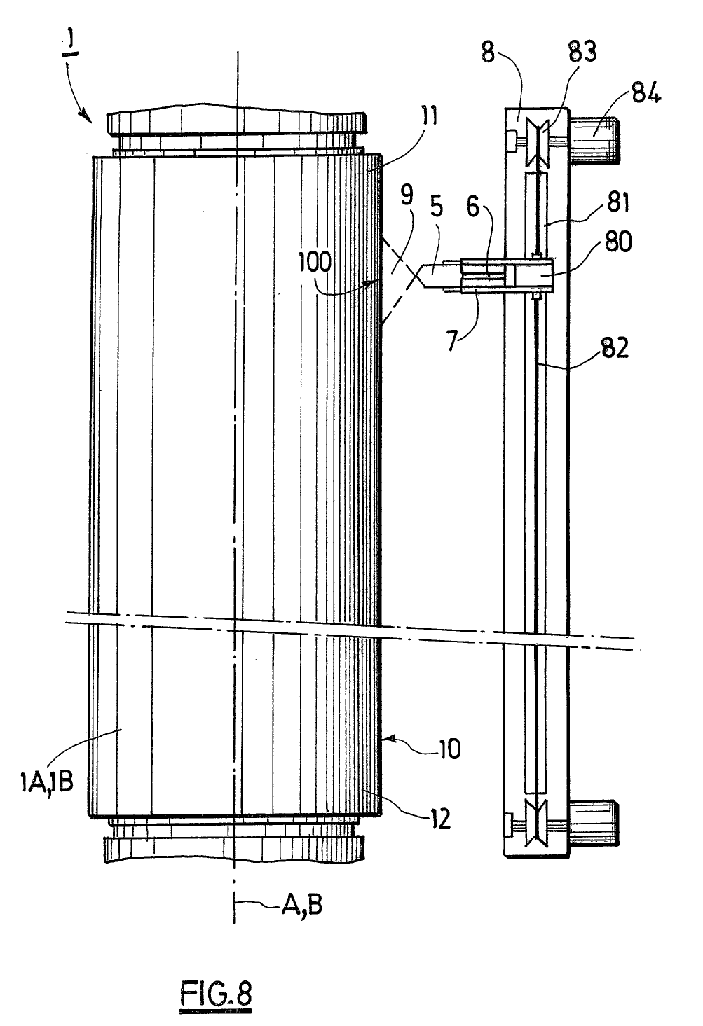

FIG. 8 is a simplified view, seen from above, of a twin-roll continuous casting machine equipped with coating means according to a possible embodiment of the invention.

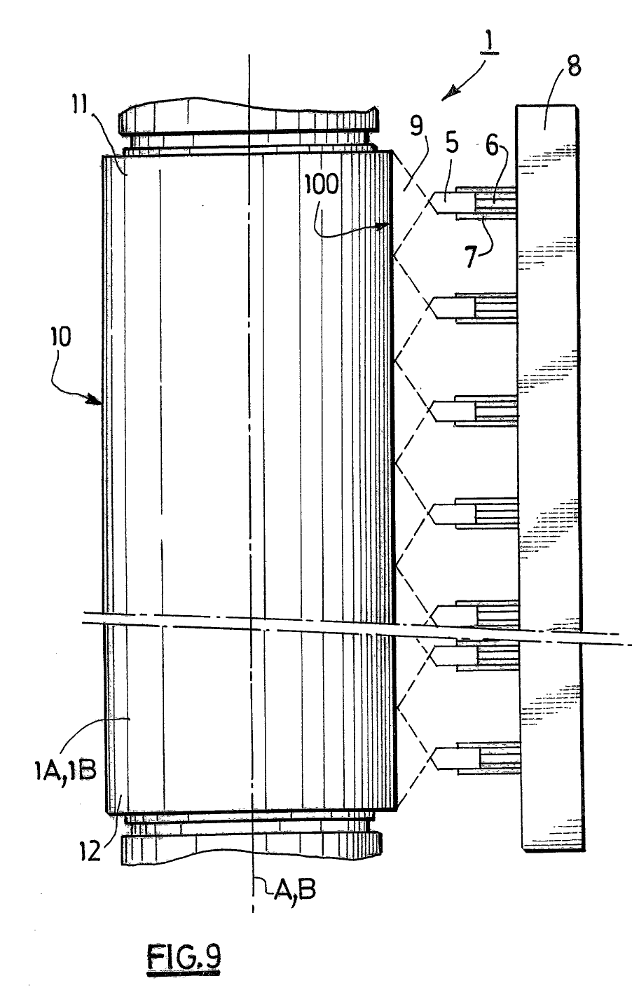

FIG. 9 is a simplified view, seen from above, of a twin-roll continuous casting machine equipped with coating means according to a possible embodiment of the invention.

### DETAILED DESCRIPTION OF THE INVENTION

As shown in FIG. 1, a machine (1) for twin-roll continuous casting typically includes two horizontal rolls (1A, 1B) and an injector (2). The rolls (1A, 1B) are typically made of metal and generally have the same diameter. The rotation axes (A, B) of the rolls (1A, 1B) are, in general, approximately parallel to each other. The rolls are separated by a gap (13) and are able to rotate in the opposite direction relative to each other.

The liquid metal (3) is fed on one side of the gap (13) by means of the injector (2) and emerges on the other side in a solid state, in the form of a strip (4) having a nominal thickness Eo which is approximately equal to the aperture E of the gap (13). The surface (10) of the rolls is cooled in a continuous way, typically by means of a cooling fluid circulating inside the rolls.

Casting is said to be horizontal when the plane A-B containing the axes of the rolls (1A) and (1B) is approximately vertical. It is said to be inclined when said plane A-B is inclined relative to the vertical. It is said to be vertical when said plane A-B is approximately horizontal.

A twin-roll continuous casting machine is normally equipped with coating means typically including means (5) for spraying the release product (24), support means (7, 8) of said spray means, a source (22) of release product (24), a stirrer (23), and piping (6, 21) to convey the release product (24) and a means (20) for regulating the flow of the release product. The release product source (22) is typically a tank with a capacity of about 100 to 200 liters.

According to the invention, the process for coating the rolls (1A, 1B) of a twin-roll continuous casting machine (1) includes the application of at least one release product (24) on said rolls, said release product containing a release agent and a carrier fluid, and is characterised in that it includes an adjustment of the composition of said release product (24) while it is applied to said rolls.

The invention is based on the idea of varying the composition of the release product so as to avoid variations in the size of the jets and in the distribution of the release agent inside the spray cone or “jets” (9, 91, 92) and on the impact surface (100, 101, 102) which may appear when variations are made to the flow of the spray means (5, 51, 52).

The release agent preferably includes graphite, typically in the form of micron size particles. The carrier fluid preferably includes water. The graphite is in suspension in the carrier fluid, possibly in a colloidal form, with a concentration typically between 0.2 and 4% by weight.

In the preferred embodiment of the invention, said adjustment of the composition comprises an adjustment of the proportion of release agent contained in the release product, in other words of the concentration of release agent in said release product. Thus, it is possible to modify the quantity of release agent sprayed onto the roll by modifying the proportion of release agent in the release product, without modifying the flow of the spray means: the proportion of release agent is increased when it is required to spray a greater quantity of release agent onto the surface (10) of the roll and it is reduced in the reverse situation.

Preferably, the adjustment of the composition comprises a dilution of a release agent concentrate in a carrier fluid. Said concentrate may be a “mother suspension”, a concentrated solution or a mixture thereof. Said concentrate is advantageously selected from among concentrated suspensions of graphite, boron nitride, colloidal silica, magnesia, organic products (such as organic oils or polyesters) or a mixture thereof. Typically, a mother suspension may be used which is a concentrate of graphite particles in suspension in a gel, with a proportion of graphite typically between 20 and 30% by weight. The carrier fluid is then generally water. The proportion of mother suspension added to the carrier fluid is typically between 1 and 8%.

In practice, it may be advantageous for the process according to the invention also to comprise an adjustment of the release product flow so as to obtain a stability of the jet in time, in particular between the moment when the guns are adjusted relative to the rolls, outside casting and during casting.

The adjustment of the composition may be carried out retroactively as a function of measurements carried out on the casting machine (1) (typically by means of a regulation loop) and/or in an automated way. Said measurements typically include measurements selected from among optical, laser, infrared, vibration, or mechanical tension measurements. For example, the quantity of release agent present on the surface (10) of the rolls may be determined by means of a sensor (such as an optical sensor, a laser system, a camera or an infrared sensor) which produces a signal which may be used retroactively in order to regulate the composition of the release product. Said adjustment of the composition may then correspond to a regulation. The process of the invention may be included in a process of regulating a twin-roll continuous casting machine.

According to the invention, the device for coating a roll (1A, 1B), which is suitable for use on a twin-roll continuous casting machine, includes coating means (5, 51, 52, 6, 61, 62, 7, 8, 20, 21) for applying at least one release product (24) to said rolls and is characterised in that it includes means (30 to 41) for adjusting the composition of the release product while it is applied to said rolls.

The coating device according to the invention is appropriate to implement the coating process of the invention.

The coating means advantageously include means (20) for controlling the flow of the spray means (5, 51, 52), such as a volumetric pump.

The conduits (6, 21) may be made of different materials compatible with the release product and the ambient conditions of a continuous casting machine. When the spray means are mobile, a part (6) of the conduits is preferably flexible.

The coating means may be placed at different places on the periphery of the rolls. They are however advantageously placed on the output side, in other words on the metal strip side, so as not to be in contact with the liquid metal, which could constitute an explosion hazard.

In the very frequent case in which the release product comprises a carrier fluid, such as water, and a solid release agent, such as graphite, the coating means according to the invention may also include means (38, 39), active or passive, such as a stirrer (38) or a baffle (39), to homogenise the release product. The coating means according to the invention may possibly include means (38) to maintain in suspension the particles of release agent.

In a preferred embodiment of the invention, which is shown in FIG. 3, said means (30 to 41) of adjusting the composition of the release product include a mixer (40), a release agent feed (41), a means (32) of regulating the release agent feed and a carrier fluid feed (30). The regulation means (32) makes it possible to control and to regulate the quantity of release agent which is brought to the mixer (40) and applied to the rolls by the coating means. The regulation means (32) may include, for example, a measuring pump.

Said mixer (40) may also be a venturi tube, a buffer tank or a crucible. The mixer (40) is to advantage of very low capacity (for example 1 to 2 liters), which makes it possible particularly to vary rapidly the concentration of release agent contained in the release product. The mixer (40) may be common to several spray means.

FIG. 4 shows two embodiments of said adjustment means (30 to 41). In the embodiment in FIG. 4a), said adjustment means (30 to 41) include a tank (34) fit to contain said concentrate (35), a means (32) of regulating the release agent feed, channelling means (31, 33), a carrier fluid feed (30), a flow tank (36) fit to contain the release product (24), a mixing zone (37) and a stirrer (38). In the embodiment in FIG. 4b), said adjustment means (30 to 41) include a tank (34) able to contain said concentrate (35), a means (32) of regulating the release agent feed, channelling means (31, 33), a carrier fluid feed (30), a container (36) fit to contain the release product (24), a mixing zone (37), baffles (39) and a stirrer (38).

The applicant has had the idea that diluting a concentrate of release agent in a carrier fluid in a mixer (40), particularly when the latter is of low capacity, might make it possible to avoid the problems of sedimentation of the release agent which are often observed with known devices (which operate generally in “batch” mode using large capacity tanks (22), that is typically between 100 and 200 liters) and which bring about fluctuations in the effective composition of the release product relative to the nominal value. Using one or more low capacity mixers (40) also makes it possible to reduce their volume and, consequently, the size of the casting installations. It also allows the controls to be simplified.

When the release agent is presented in the form of a concentrate (35) that can be diluted by means of the carrier fluid, the release agent feed (41) advantageously includes a tank (34), from which it is possible to feed, in a regulated way, the mixer (40).

The means (30 to 41) for adjusting the composition of the release product may form an adjustment device (42), which is advantageously distinct, detachable and/or able to be dismantled, which ensures ease of maintenance.

The coating device of the invention may include means for controlling retroactively said adjustment of the composition as a function of measurements carried out on said casting machine, for example by means of a regulation loop. It may also include means for controlling in an automated way said adjustment of the composition.

The spray means (5, 51, 52) are typically selected from the group including nozzles and guns. The coating means may include a single spray means (5) per roll (FIG. 1) or several spray means (51, 52) per roll (FIGS. 7 and 9). In the latter case, the spray means may be superposed (as shown in FIG. 7) or distributed along the roll (as shown in FIG. 9). The coating means may also include means for displacing the spray means along the roll, typically in an oscillatory motion of or in a to-and-fro motion between one end (11) and the other (12) of the roll.

According to an advantageous variant of the invention, said coating means include a spray means (5) for each roll (1A, 1B) and means (80 to 84) for displacing said spray means (5) along each roll, typically in a to-and-fro motion.

According to another advantageous variant of the invention, said coating means include at least two spray means (51, 52) for each roll (1A, 1B), said spray means forming an integral unit, and means (80 to 84) for displacing each said unit along each roll, typically in a to-and-fro motion. The spray means of each said unit are advantageously superposed, as shown in FIG. 7, when it is intended to produce strips of great width (which is normally made difficult by the limited maximum speed of the displacement means of the spray means).

The displacement means (80 to 84) typically include a mobile support or carriage (80), a rail (81) and drive means (82, 83, 84) such as a motor. Preferably, said displacement means (80 to 84) make it possible to displace said spray means in a to-and-fro motion along an axis parallel to the axis (A, B) of the roll.

According to another advantageous variant of the invention, said coating means include at least two spray means (5) for each roll and said spray means are placed on a line approximately parallel to the axis (A, B) of each said roll (1A, 1B). The spray means are typically equidistant.

The orientation of the spray means may be fixed or variable. The device according to the invention may also comprise means for making at least one of the spray means oscillate relative to a specific axis, which makes it possible to increase the impact surface of the spray means and, possibly, to reduce their number. The axis of oscillation is typically vertical.

The invention is particularly advantageous in the case when at least two spray means per roll are used. Indeed, in such cases, the coverage of the spray cones (9, 91, 92) and the impact surfaces (100, 101, 102) may entail significant variations in the distribution of the total release agent from the multiple spray means. For example as diagrammatically shown in FIG. 5, where D represents the release agent surface density, the total impact surface of two juxtaposed spray means may be subject not only to radial variations in density, as is the case with a single spray means, but also to very significant variations in density in the contact zone between the spray cones and the impact surfaces, even if the coating may be near to the nominal value N in the zones S where the impact surfaces are not covered. FIG. 5a) corresponds to the case where the two jets form an angle which is relatively closed in relation to the required optimum value; the overlap between the spray cones and the two impact surfaces is in this case very low or nil, which leads to zones of insufficient coating E relative to the nominal value N. FIG. 5b) corresponds to the case where the two jets form an angle which is relatively open in relation to the required optimum value; the overlap between the spray cones and the two impact surfaces is in this case not negligible, and may even be significant, which leads to zones of excess coating R relative to the nominal value N. FIG. 6 shows that a similar effect may occur even if the overlapping areas between the impact surfaces are very significant. In the latter case, the quantity of release agent applied in certain zones may fluctuate in a very significant way, running from insufficient coating in some zones T when the angle of the jets is relatively closed relative to the required optimum value (FIG. 6a) to excess coating in the same zones T when the angle of the jets is relatively open (FIG. 6b).

The twin-roll continuous casting machine (1) according to the invention may include at least one sensor for determining the quantity of release agent present on the surface (10) of the rolls which produces a signal that can be used retroactively for adjusting the composition of the release product. Said sensor is typically selected from among optical sensors, laser systems, cameras, infrared sensors, vibration sensors and mechanical tension sensors.

In the regulation process according to the invention, said adjustment may be carried out as a function of the operating conditions of said machine (1). It may also be carried out retroactively as a function of measurements carried out on said casting machine, for example by means of a regulation loop.

Said measurements may include measurements selected from among optical, laser, infrared, vibration or mechanical tension measurements. Said adjustment of the composition may also be carried out in an automated way.

The invention relates above all to the production of strips of non-ferrous metals, particularly aluminium or aluminium alloy or copper or copper alloy.

### EXAMPLES

Strips of aluminium alloy 1100 in the nomenclature of the Aluminium Association, 3 mm thick and 1800 mm wide, were cast according to the invention at speeds reaching 3.5 mm/min under 1000 t/side of clamping force, using a mother suspension of graphite at 21% diluted in water with an adjustment of the proportion of graphite between about 2% and 3%. The surface quality of the strips was verified by full width macro-etching testing of samples. The applicant noted a significant improvement in the surface quality of the strips, a greater reproducibility of this quality and productivity about 10% higher than that observed for casting carried out with a coating in the batch mode, with large capacity tanks and a simple regulation of the release product flow. It attributes these improvements to a more uniform and better-controlled distribution of release agent.

### ADVANTAGES OF THE INVENTION

The invention, which may be incorporated into existing processes and devices for twin-roll continuous casting, makes it possible to improve the quality of the strips obtained and the consistency of the deposit of release agent on the rolls. The quality is particularly improved by the adjustment of the jets which may remain the same whatever the field of operation of the machine. For a given operational capacity, the consistency of the deposit allows an appreciable reduction in the quantity of release product required to obtain strips of specific quality.

1. A process for coating the rolls (1A, 1B) of a twin-roll continuous casting machine (1) including the application of at least one release product to said rolls, said release product containing a release agent and a carrier fluid, characterised in that it includes an adjustment of the composition of said release product while it is applied to said rolls.

2. A coating process according to claim 1, characterised in that said adjustment of the composition comprises an adjustment of the proportion of release agent contained in the release product.

3. A coating process according to claim 1 or 2, characterised in that it additionally comprises an adjustment of the release product flow.

4. A coating process according to any one of the claims 1 to 3, characterised in that the release product is a suspension, a solution or a mixture thereof.

5. A coating process according to any one of the claims 1 to 4, characterised in that the release agent includes graphite.

6. A coating process according to any one of the claims 1 to 5, characterised in that the carrier fluid includes water.

7. A coating process according to any one of the claims 1 to 6, characterised in that said adjustment of the composition comprises a dilution of a concentrate of release agent in said carrier fluid.

8. A coating process according to claim 7, characterised in that said concentrate is a mother suspension, a concentrated solution or a mixture thereof.

9. A coating process according to claim 7 or 8, characterised in that said concentrate is selected from among concentrated suspensions of graphite, boron nitride, colloidal silica, magnesia, organic products or a mixture thereof.

10. A coating process according to claim 7 or 8, characterised in that said concentrate is a graphite gel containing between 20 and 30% by weight of graphite.

11. A coating process according to any one of the claims 1 to 10, characterised in that said adjustment of the composition is carried out retroactively as a function of measurements carried out on said casting machine.

12. A coating process according to claim 11, characterised in that it includes a regulation loop.

13. A coating process according to claim 11 or 12, characterised in that said measurements include measurements selected from among optical, laser, infrared, vibration, or mechanical tension measurements.

14. A coating process according to any one of the claims 1 to 13, characterised in that said adjustment of the composition is carried out in an automated way.

15. A process for twin-roll continuous casting of metal strips including a coating process according to any one of the claims 1 to 14.

16. A continuous casting process according to claim 15, characterised in that said metal strips are made of aluminium, aluminium alloy, copper or copper alloy.

17. A device for coating rolls (1A, 1B) of a twin-roll continuous casting machine (1) including coating means (5, 51, 52, 6, 61, 62, 7, 8, 20, 21) for applying at least one release product (24) to said rolls, characterised in that it includes means (30 to 41) for adjusting the composition of said release product while it is applied to said rolls.

18. A coating device according to claim 17, characterised in that said means for adjusting the composition include a mixer (40), a release agent feed (41), a means (32) of regulating the release agent feed and a carrier fluid feed (30).

19. A coating device according to claim 18, characterised in that the regulation means (32) includes a measuring pump.

20. A coating device according to claim 18 or 19, characterised in that the release agent feed (41) includes a tank (34) fit to contain a release agent concentrate (35).

21. A coating device according to any one of the claims 17 to 20, characterised in that it includes means (38, 39) for homogenising the release product.

22. A coating device according to any one of the claims 17 to 21, characterised in that the coating means include means (20) for controlling the flow of the spray means (5, 51, 52).

23. A coating device according to any one of the claims 17 to 22, characterised in that said coating means include a spray means (5) for each roll (1A, 1B) and means (80 to 84) for displacing said spray means (5) along each roll.

24. A coating device according to any one of the claims 17 to 22, characterised in that said coating means include at least two spray means (51, 52) for each roll (1A, 1B), said spray means forming an integral unit, and means (80 to 84) for displacing each said unit along each roll.

25. A device according to claim 24, characterised in that the spray means of each said unit are superposed.

26. A device according to any one of the claims 23 to 25, characterised in that said displacement means (80 to 84) make it possible to displace said spray means in a to-and-fro motion along an axis parallel to the axis (A, B) of the rolls.

27. A coating device according to any one of the claims 17 to 22, characterised in that said coating means include at least two spray means (5) for each roll and in that said spray means are placed on a line approximately parallel to the axis (A, B) of each said roll (1A, 1B).

28. A coating device according to any one of the claims 17 to 27, characterised in that it comprises means for making at least one of the spray means oscillate relative to a specific axis.

29. A coating device according to any one of the claims 17 to 28, characterised in that the spray means (5, 51, 52) are selected from the group including nozzles and guns.

30. A coating device according to any one of the claims 17 to 29, characterised in that it includes means for controlling retroactively said adjustment of the composition as a function of measurements carried out on said casting machine.

31. A coating device according to any one of the claims 17 to 30, characterised in that it includes means for controlling in an automated way said adjustment of the composition.

32. A coating device according to any one of the claims 17 to 31, characterised in that said means (30 to 41) for adjusting the composition of the release product may form an adjustment device (42), which is distinct, detachable and/or able to be dismantled.

33. A machine for twin-roll continuous casting of metal strips equipped with a coating device according to any one of the claims 17 to 32.

34. A machine according to claim 33, characterised in that it includes at least one sensor for determining the quantity of release agent present on the surface (10) of the rolls which produces a signal able to be used retroactively for adjusting the composition of the release product.

35. A machine according to claim 34, characterised in that said sensor is selected from among optical sensors, laser systems, cameras, infrared sensors, vibration sensors and mechanical tension sensors.

36. A process for regulating a machine (1) for twin-roll continuous casting of metal strips including the application of at least one release product on said rolls, said release product containing a release agent and a carrier fluid, characterised in that it includes an adjustment of the composition of said release product while it is applied to said rolls.

37. A regulation process according to claim 36, characterised in that said adjustment is carried out as a function of the operating conditions of said machine (1).

38. A regulation process according to claim 36 or 37, characterised in that said adjustment of the composition is carried out retroactively as a function of measurements carried out on said casting machine.

39. A regulation process according to claim 38, characterised in that it includes a regulation loop.

40. A regulation process according to claim 38 or 39, characterised in that said measurements include measurements selected from among optical, laser, infrared, vibration, or mechanical tension measurements.

41. A regulation process according to any one of the claims 36 to 40, characterised in that said adjustment of the composition is carried out in an automated way.
